(19) United States
(12) Patent Application Publication
(10) Pub. No.: US 2006/0085910 A1
(43) Pub. Date: Apr. 27, 2006

(54) Systems and methods for providing a backboard with a track

(76) Inventor: Nathan R. Walkingshaw, Sandy, UT (US)

Correspondence Address: Jarod R. Marrott;KIRTON & McCONKIE, Suite 1800, 60 East South Temple, Salt Lake City, UT, 84111, US

(21) Appl. No.: 11/254,458

(22) Filed: Oct. 20, 2005

Related U.S. Application Data
(60) Provisional application No. 60/621,791, filed on Oct. 25, 2004.

(51) Int. Cl. A61G 1/017; A61G 7/10

(52) U.S. Cl. 5/81.1 R; 5/626

(57) ABSTRACT

A tracked backboard having a track system hingedly attached and handles for lifting one end of the backboard off of the ground. The track system, when unlocked from the backboard, pivots downward and remains on the terrain so as to provide traction throughout the length of the track. In one embodiment, the system is constructed so as to be long enough to span at least two stair treads to provide smooth transit down stairwells. The track system hinges freely to hug the terrain over which the backboard is traversing. A brake system is provided within the tracking system to slow the descent of the backboard.

### 1. RELATED APPLICATIONS

This application claims priority to U.S. Provisional Patent Application Ser. No. 60/621,791 filed Oct. 25, 2004, entitled BACKBOARD WITH A TRACK.

### BACKGROUND OF THE INVENTION

1. Field of the Invention

The present invention relates to a patient backboard. In particular, the present invention relates to systems and methods for providing a backboard which has attached to a portion thereof a track system for providing mobility for the backboard over uneven terrain. Stairs, rough outdoor terrain and difficult situations to move a patient can be overcome even with only one operator. A braking system is provided to slow the descent of a patient and to help control the descent of the patient and the operator of the backboard when descending.

2. Background and Related Art

Backboards have been used by paramedics for quite some time in stabilizing the body of a patient so that further injury does not occur during transport. Backboards are traditionally a rigid platform to which handles are attached or in which handles are formed and usually involve the cooperation of two people to carry the patient from one location to another. Since backboards are rigid, when descending a stairway, the individual supporting the end of the backboard on the downhill side must typically lift the backboard as high as possible to maintain a level platform on which the patient can be retained. This is awkward and often dangerous for the individual at the lower end of the backboard.

In a similar manner, to help alleviate the strain on the individual at the bottom of the backboard, the individual at the higher end must often stoop so as to lower his or end of the backboard and attempt to provide a more level surface for the patient. This stooping position while descending stairs is also very dangerous for the upper person as they may trip and at the very least expose themselves to potential back strain.

Another problem in descending terrain is that the weight of the patient in the backboard plus a portion of the weight of the upper person is borne by the lower person. Although this causes physiological strain on the lower person, there is also a traction problem in that soles of the shoes of the lower person must have a frictional coefficient high enough to resists slippage when descending. If the ground is wet or uneven, the weight of the patient and a portion of the weight of the upper person may make it difficult to maintain footing, or in some cases, may result in the lower person attempting to go faster to compensate for lost traction with the result that the upper person cannot keep up and may trip.

Thus, while techniques currently exist that are used to provide support to a patient that is being moved, challenges still exist. Accordingly, it would be an improvement in the art to augment or even replace current techniques with other techniques.

### SUMMARY OF THE INVENTION

The present invention relates to a patient backboard. In particular, the present invention relates to systems and methods for providing a backboard which has attached to a portion thereof a track system for providing mobility for the backboard over uneven terrain. Stairs, rough outdoor terrain and difficult situations to move a patient can be overcome even with only one operator. A braking system is provided to slow the descent of a patient and to help control the descent of the patient and the operator of the backboard when descending.

Implementation of the present invention embraces a rigid backboard that is hinged at the end thereof to a track system. The track system can lock against the backboard or can be pivoted downward so that the track is in full contact with the terrain over which the backboard is being moved. A single individual can operate the backboard by lifting the end that is opposite the tracks off of the ground and placing most of the weight of the backboard and patient on the tracks. By moving forward, the tracks begin to rotate around the bogies that retain the track to the track system, allowing forward propulsion of an individual over terrain. The track system is equipped with a brake that can be operated by a hand control located at the operator's end of the cot. Handles also pop out of the operator's end to provide for easier operation of the backboard and also providing a mounting point for the handbrake.

In at least one implementation, the backboard includes a cam bar which in one position allows backboard supports to be located against the bottom of the backboard and in a second torqued position urges the supports downward from their stored position into a support position 90° from the stored position. As such, the backboard may be placed on a surface off of the ground to provide for easier care of the patient.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a top planar view of a representative embodiment of the present invention that includes a backboard with pop out handles in an extended position;

FIG. 2 illustrates a front elevational view of the representative embodiment of FIG. 1 with the track system;

FIG. 3 illustrates a side elevational view of the representative embodiment of FIG. 1 with the track system pivoted outward from the backboard;

FIG. 4 illustrates a side elevational view of the representative embodiment of FIG. 1 with a brake system for slowing the track;

FIG. 5 illustrates a top planar view of another representative embodiment of the present invention in an extended position;

FIG. 6 illustrates a bottom planar view of the representative embodiment of FIG. 5 in an extended position;

FIG. 7 illustrates a side view of a representative embodiment the present invention in a folded or chair position;

FIG. 8 illustrates a bottom planar view of the representative embodiment of FIG. 7 in a folded or chair position;

FIG. 9 illustrates a front perspective view of the embodiment of FIG. 7 in a folded or chair position;

FIG. 10 illustrates a back perspective view of the embodiment of FIG. 7 in a folded or chair position; and

FIG. 11 illustrates a bottom perspective view of the embodiment of FIG. 7 in a folded or chair position.

### DETAILED DESCRIPTION OF THE INVENTION

The present invention relates to backboard. In particular, the present invention relates to systems and methods for providing a backboard which has attached to a portion thereof a track system for providing mobility for the backboard over uneven terrain. Stairs, rough outdoor terrain and difficult situations to move a patient can be overcome even with only one operator. A braking system is provided to slow the descent of a patient and to help control the descent of the patient and the operator of the backboard when descending.

It will be readily understood that the components of the present invention, as generally described and illustrated in the figures herein, could be arranged and designed in a wide variety of different configurations. Thus, the following more detailed description of the embodiments of the system and method of the present invention is not intended to limit the scope of the invention, as claimed, but is merely representative of the presently preferred embodiments of the invention.

Embodiments of the present invention embrace a rigid backboard that is hinged at the end thereof to a track system. The track system can lock against the backboard or can be pivoted downward so that the track is in full contact with the terrain over which the backboard is being moved. A single individual can operate the backboard by lifting the end that is opposite the tracks off of the ground and placing most of the weight of the backboard and patient on the tracks. By moving forward, the tracks begin to rotate around the bogies that retain the track to the track system, allowing forward propulsion of an individual over terrain. The track system is equipped with a brake that can be operated by a hand control located at the operator's end of the cot. Handles also pop out of the operator's end to provide for easier operation of the backboard and also providing a mounting point for the handbrake.

In at least one embodiment, the backboard includes a cam bar which in one position allows backboard supports to be located against the bottom of the backboard and in a second torqued position urges the supports downward from their stored position into a support position 90° from the stored position. As such, the backboard may be placed on a surface off of the ground to provide for easier care of the patient.

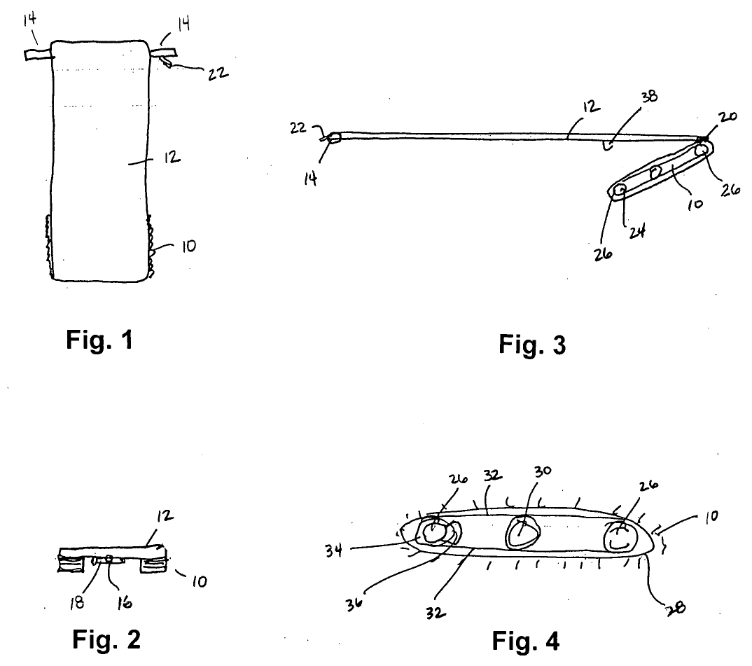

With reference now to FIG. 1, a top planar view of a representative embodiment of the present invention that includes a backboard with pop out handles in an extended position is illustrated. In FIG. 1, track system 10 is coupled underneath a backboard 12, which is configured to receive a patient. Projecting from under backboard 12 are two pop-out handles 14 that facilitate a user in maneuvering backboard 12.

With reference to FIG. 2, a front view of the representative embodiment of FIG. 1 with the track system is illustrated. Track system 10 is located under backboard 12 to support backboard 12 off the ground. In the illustrated embodiment, track system 10 is approximately 1⅞ inches high. Also illustrated in FIG. 2 is cam bar 16, which is located along the longitudinal axis of backboard 12 and recessed partially within backboard 12. Supports 18 are illustrated a stored position against the bottom of backboard 12.

With reference to FIG. 3, a side elevational view of the representative embodiment of FIG. 1 is illustrated with the track system pivoted outward from the backboard. Specifically, hinge 20 couples track system 10 to backboard 12. A user may either lift the end of the backboard opposite the track system or utilize pop-out handles 14 for an easier grip to lift one end of the backboard system or cot. Track system 10 is deployed away from the bottom of backboard 12 in FIG. 3. In the illustrated position, the track system may be used to descend an incline or hill.

While applying a hand control 22, brake system 24 slows the progress of the track over bogies 26 and reduces the rate of descent. In accordance with at least some embodiments of the present invention, only one person is needed to carry a patient on a backboard down a hill. In the illustrated embodiment, track system 10 is long enough to span the treads of at least two stairs, thereby providing a smooth descent down stairways.

With reference now to FIG. 4, a side view of the representative embodiment of FIG. 1 is illustrated with a brake system for slowing the track. In FIG. 4, track system 10 is shown having a toothed belt 28 which engages bogies 26 and is supported midpoint by a mid-bogie 30 and guides 32. Mid-bogie 30 projects through a gap in the middle of guides 32 to maintain engagement with belt 28. A brake disc 34 rotates with one of the bogies and has caliper 36 clasped around it. Caliper 36 is cable operated by the hand control located at the other end of the backboard.

The rate of descent can be controlled by applying pressure between caliper 36 and brake disc 34. It will be appreciated that embodiments of the present invention embrace other braking systems, including a drum brake system.

In one embodiment of the present invention, a track system is provided on either edge of the backboard. The track system is hinged at the center of the end of the backboard, as can be seen in FIG. 2.

Track system 10 is designed to swing up to 90°, however, it has been found that the optimal range of motion is between 0° and 30°. Further, track system 10 can be locked in position against the bottom of the backboard so that it is unobtrusive when not in use. A lock 38 is attached to the bottom of the backboard and engages track system 10 in the center thereof.

While the track system is shown pivoting from the end of backboard 12 in FIG. 3, it is appreciated that the track system pivot may be located inward from the end of the backboard. In addition, a portion of the backboard may hinge with the track system.

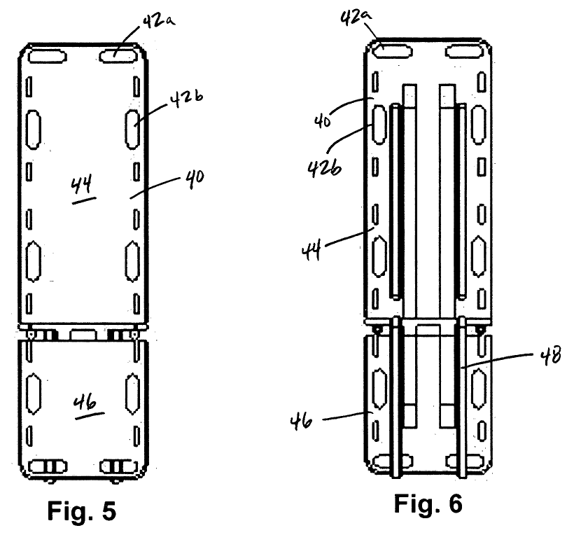

With reference now to FIGS. 5-6, a top planar view and a bottom planar view of another representative embodiment of the present invention are respectively illustrated. Backboard 40 is in an extended position and includes one or more handles 42. Backboard 40 comprises a first portion 44 pivotably coupled to a second portion 46. Accordingly, backboard 40 can be positioned in an extended position, as illustrated in FIGS. 5-6, or in a hinged or chair position, as will be further illustrated below. Backboard 40 further includes track system 48 that facilitates selective movement of the backboard 40, such as in the transport of a patient.

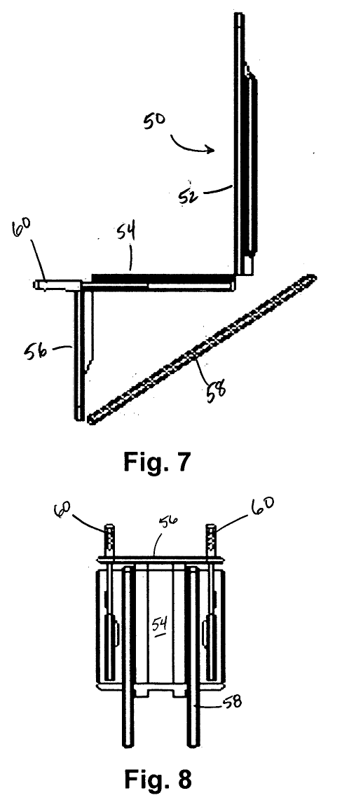

With reference to FIG. 7, a side view of a representative embodiment is illustrated in a folded or chair position. In FIG. 7, backboard 50 is placed into a folded position by pivoting the front surface of first portion 52 toward the front surface of second portion 54, such that first portion 52 forms a back and second portion 54 forms a seat. Additonally, a front surface of third portion 56 is pivoted away from the front surface of the second portion 54. Accordingly, in at least one embodiment, third portion 56 provides support to track system 58 when backboard 50 is in a hinged or chair position. Additionally, one or more handles 60 are provided to assist the patient in staying on backboard 50 during transport, and includes a brake system to slow and/or stop movement of track system 58.

With reference now to FIG. 8, a bottom planar view of the representative embodiment of FIG. 7 is illustrated in a folded or chair position.

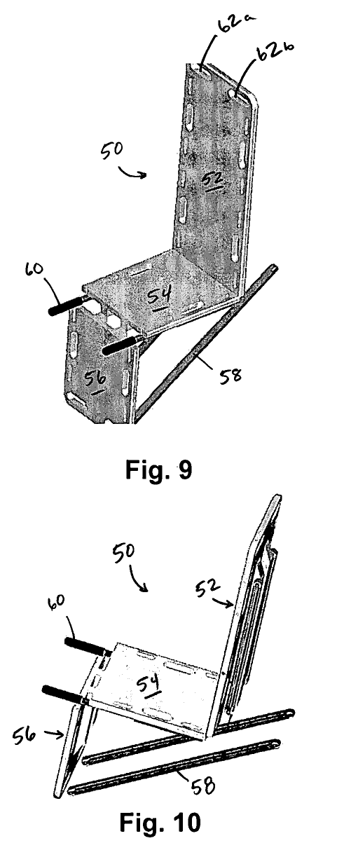

With reference to FIG. 9, a front perspective view of the embodiment of FIG. 7 is illustrated in a folded or chair position. In FIG. 9, backboard 50 comprises a plurality of handles 62 to facilitate a user in holding onto and/or transporting backboard 50.

With reference to FIG. 10, a back perspective view of the embodiment of FIG. 9 is illustrated in a folded or chair position, and demonstrates the descent down an incline through utilization of track system 58.

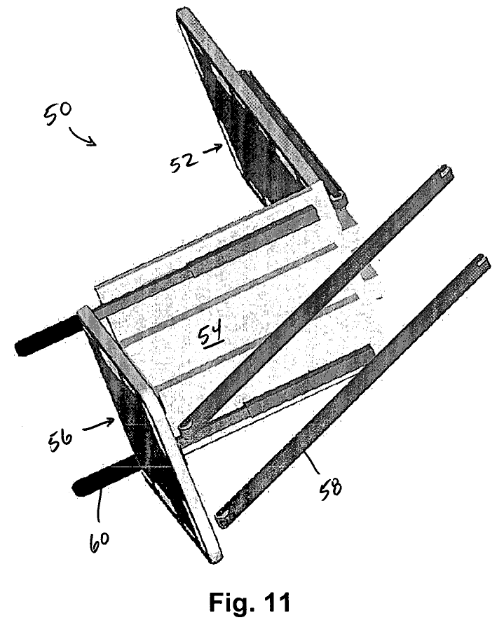

With reference to FIG. 11, a bottom perspective view of the embodiment of FIG. 9 is illustrated with backboard 50 being in a folded or chair position.

Thus, as discussed herein, the embodiments of the present invention embrace backboards. In particular, embodiments of the present invention relate to systems and methods for providing a backboard which has attached to a portion thereof a track system for providing mobility for the backboard over uneven terrain. Stairs, rough outdoor terrain and difficult situations to move a patient can be overcome even with only one operator. A braking system is provided to slow the descent of a patient and to help control the descent of the patient and the operator of the backboard when descending.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A tracked backboard system comprising:
a backboard configured to receive a patient; and
a track system coupled to the backboard to support one end of the backboard.

2. A tracked backboard system as recited in claim 1, wherein the track system is hingedly coupled to the backboard.

3. A tracked backboard system as recited in claim 1, further comprising handles located at a first end of the backboard, wherein the handles are configured for selectively lifting the backboard off of the ground.

4. A tracked backboard system as recited in claim 3, further comprising a braking system coupled to the track system to selectively control a rate of rotation of the track system.

5. A tracked backboard system as recited in claim 4, wherein the braking system includes a hand control that is coupled to the backboard.

6. A tracked backboard system as recited in claim 4, wherein the braking system is controlled by a hand control located on the handles.

7. A tracked backboard system as recited in claim 1, wherein a bogie system is utilized to maintain a rotating track of the track system in a taut configuration.

8. A track system for attachment to a patient backboard, the track system comprising:
a bogie attached to a frame, said bogie capable of rotation;
a biasing spring for biasing the bogie in one direction;
a rotatable track about the outside of the bogie; and
a hinge assembly coupling the track system to the patient backboard.

9. A track system as recited in claim 8, wherein the track system is supports one end of the patient backboard.

10. A track system as recited in claim 8, wherein the patient backboard comprises a plurality of backboard portions pivotably interconnected to enable the patient backboard to be positioned in one of (i) an extended postion and (ii) a hinged position.

11. A track system as recited in claim 8, wherein the patient backboard further comprises handles located at a first end of the backboard, wherein the handles are configured for selectively lifting the backboard off of the ground.

12. A track system as recited in claim 11, wherein the braking system is controlled by a hand control located on the handles.

13. A track system as recited in claim 8, further comprising a braking system coupled to the track system to selectively control a rate of rotation of the track system.

14. A track system as recited in claim 13, wherein the braking system includes a hand control that is coupled to the backboard.

15. A track system as recited in claim 8, wherein a bogie system is utilized to maintain a rotating track of the track system in a taut configuration.

16. A backboard system comprising:
a backboard configured to receive a patient, wherein the backboard comprises a plurality of portions pivotably interconnected; and
a track system coupled to the backboard to support at least one end of the backboard.

17. A backboard system as recited in claim 16, wherein the track system is hingedly coupled to the backboard.

18. A backboard system as recited in claim 16, wherein the backboard further comprises one or more handles.

19. A backboard system as recited in claim 16, further comprising a braking system coupled to the track system to selectively control a rate of rotation of the track system.

20. A backboard system as recited in claim 16, wherein a bogie system is utilized to maintain a rotating track of the track system in a taut configuration.
